(19) United States
(12) Patent Application Publication
(10) Pub. No.: US 2005/0153198 A1
(43) Pub. Date: Jul. 14, 2005

(54) Oxygen reduction electrode and electrochemical element using same

(75) Inventors: Masa-aki Suzuki, Osaka (JP); Yuka Yamada, Nara-shi (JP); Nobuyasu Suzuki, Nara-shi (JP); Yasunori Morinaga, Osaka (JP); Hidehiro Sasaki, Osaka (JP); Tadashi Sotomura, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD., Osaka (JP)

(21) Appl. No.: 11/004,898

(22) Filed: Dec. 7, 2004

Related U.S. Application Data
(63) Continuation of application No. PCT/JP04/04948, filed on Apr. 6, 2004.

(30) Foreign Application Priority Data
Apr. 8, 2003 (JP) 2003-103948

(51) Int. Cl. H01M 4/00

(52) U.S. Cl. 429/128; 204/294

(57) ABSTRACT

Methods of effectively utilizing yeast-containing waste products generated after yeast use can be applied to absorbing agents, drying agents, soil conditioners, catalysts, and other common applications in the same manner as to charcoal-based materials of other materials by carbonizing the waste product, but a new search was needed in order to broaden the industrial utilization of these products. By supporting a particulate or powdered charcoal-based material obtained by carbonizing a yeast-containing material on an electrically conductive gas-permeable base, an electrode can be obtained that is capable of the electrochemical reduction of oxygen. The present charcoal-based material can provide new applications that have not been hitherto proposed, in the sense that oxygen can be electrochemically reduced smoothly and at a small overvoltage (resistance), and a large electromotive force can be obtained, by placing the charcoal-based material at the intersection of the ion path and the oxygen path.

### TECHNICAL FIELD

The present invention relates to an oxygen-reducing electrode used in a reaction for reducing oxygen, and to an electrochemical element that uses the same.

### BACKGROUND ART

It is known that when oxygen (O₂) is reduced by electrolysis, a one-electron, two-electron, or four-electron reduction takes place. A superoxide is generated in a one-electron reduction. In a two-electron reduction, hydrogen peroxide is generated. Water is generated in a four-electron reduction (for example, see Jacek Kipkowski, Philip N. Ross ed., Electrocatalysis, Wiley-VCH pub., 1998, pp. 204-205).

When the reduction of oxygen is used as the positive electrode reaction in a battery, it is necessary to obtain a battery or the like with high capacity, high voltage, and high output current. In this case, the requirements in the reduction of oxygen are that a) as many electrons be moved as possible, b) the potential be as electropositive as possible, and that c) overvoltage be suppressed as much as possible. In order to achieve this, a catalyst is preferably used that accelerates the four-electron reduction reaction at a high voltage potential and small overvoltage. One such catalyst is platinum (Pt).

However, platinum has such drawbacks as the following. (1) Platinum is a valuable rare metal and is not cost-effective. (2) Platinum is active not only in the reduction of oxygen, but also in the oxidation of ethanol, hydrogen, and other fuel substances, and is therefore poor in reaction selectivity. Because of this, oxidation reactions and reduction reactions must be isolated by a separator or the like in actual practice. (3) The surface of platinum is easily inactivated by carbon monoxide or hydroxyl groups, and high catalytic activity can be difficult to maintain.

Therefore, several attempts have been made thus far to develop a catalyst as a substitute for platinum.

For example, in Japanese Examined Patent Publication Nos. H2-030141 or H2-030142, a catalyst is proposed that consists of a fluororesin porous molded article and a conductive powder on which iron phthalocyanine, cobalt porphyrin, or other metal chelate compound possessing the ability to reduce oxygen gas is supported. It is also known that high oxygen reducing ability (four-electron reducing ability) can be achieved by using a dimer (binuclear complex) of a metal chelate compound, which can be applied to a high-output air battery.

For example, an oxygen-reducing catalyst technique is disclosed that uses a macrocyclic complex with Cr, Mn, Fe, Co, or another transition metal as the central metal thereof, such as a cobalt porphyrin binuclear complex or the like (Jacek Kipkowski, Philip N. Ross ed., Electrocatalysis, Wiley-VCH pub., 1998, pp. 232-234).

A manganese complex catalyst for oxygen reduction is disclosed in Japanese Unexamined Patent Publication No. H11-253811. This complex serves as a catalyst for performing the four-electron reduction of oxygen with high selectivity. As described in this patent reference, a manganese atom goes from a valence of two to seven, and oxygen reduction is catalyzed in a potential range of minus 0.5 V to plus 2 V.

The catalyst is often supported on a support that has excellent stability when these catalysts are actually used. When used in the electrode reaction of an electrochemical element, a carbon material is usually used as a conductive support. For example, carbon black, activated carbon, graphite, conductive carbon, vitreous carbon, and other carbon materials are used. These carbon materials are known to usually cause two-electron reduction and produce hydrogen peroxide in the electrolytic reduction of oxygen.

### DISCLOSURE OF THE INVENTION

However, a metal complex is needed whose central metal atom has a high valence if a high potential is to be obtained by using a catalyst such as those described above. Because this type of metal complex is highly reactive, drawbacks exist whereby reaction takes place with members that the metal complex is in contact with (for example, electrolytic solution, electrode leads, collectors, the battery case, separator, gas permselective film, and the like), which causes degradation of these members.

It is also known regarding the carbon material used as the support that palm nutshell activated carbon, wood charcoal, and the like have an ability to decompose hydrogen peroxide. For example, acrylic fiber charcoal, charcoals of beer lees, and the like have been disclosed as the types of activated carbon that have high performance as hydrogen peroxide decomposing catalysts (Japanese Unexamined Patent Publication Nos. H7-024315, 2003-001107, and others).

However, only generally known electrode reactions (specifically, two-electron reduction reactions) are known as the catalytic action of the carbon material itself. No particular disclosure has been made concerning the catalytic action or effectiveness thereof as an electrode catalyst for reducing oxygen.

A main object of the present invention is to provide an oxygen reduction electrode that imparts four-electron reduction with higher selectivity in a oxygen reduction reaction.

Another object of the present invention is to provide a stable oxygen reduction electrode that has virtually no oxidizing activity towards a fuel substance that is soluble in the electrolyte.

Specifically, the present invention pertains to the hereinafter-described oxygen reduction electrode and to an electrochemical element that uses the same.

1. A method for manufacturing an oxygen reduction electrode used in the four-electron reduction of oxygen, the manufacturing method comprising (1) a first step of obtaining a charcoal-based material by carbonizing a yeast-containing substance(composition), and (2) a second step of manufacturing the oxygen reduction electrode using an electrode material that contains the charcoal-based material.

2. The manufacturing method described in (1), wherein the yeast-containing substance is at least one type of beer yeast, wine yeast, sake yeast, whisky yeast, bread yeast, feed yeast, strained beer lees, sake lees, strained lees of grapes used in wine manufacturing, strained lees of barley used in whisky manufacturing, strained corn lees, and soy sauce lees.

3. The manufacturing method described in (1), wherein the yeast-containing substance is carbonized at a temperature of from 300° C. to 1200° C. in an atmosphere in which the oxygen concentration is 10% or less by volume in the first step.

4. The manufacturing method described in (3), wherein the yeast-containing substance is carbonized at a temperature of from 500° C. to 1000° C. in an atmosphere in which the oxygen concentration is 10% or less by volume in the first step.

5. The manufacturing method described in (3), wherein the atmosphere is an inert gas atmosphere.

6. The manufacturing method described in (1), wherein the charcoal-based material is further activated in the first step.

7. The manufacturing method described in (1), wherein the oxygen reduction electrode is manufactured in the second step by molding the electrode material into a prescribed shape to obtain a molded article, and laminating or pressure-bonding the molded article to an electrically conductive base.

8. The manufacturing method described in (1), wherein the oxygen reduction electrode is manufactured in the second step by making the electrode material paste-like to obtain a paste containing the electrode material, and coating the paste onto an electrically conductive base.

9. The manufacturing method described in (1), wherein an inorganic compound containing at least one type of phosphorus (P) and calcium (Ca) is added to at least one of the yeast-containing substance, the charcoal-based material, and the electrode material.

10. The manufacturing method described in (1), wherein the charcoal-based material exhibits the infrared absorption of carbon(C)-oxygen(O)-carbon(C) stretching in a range of approximately 1000 to 1200 cm⁻¹.

11. The manufacturing method described in (1), wherein the charcoal-based material exhibits the infrared absorption of carbon(C)=carbon(C) symmetric stretching at approximately 1600 cm⁻¹:

12. The manufacturing method described in (1), wherein the charcoal-based material exhibits the infrared absorption of carbon(C)=oxygen(O) stretching at approximately 1700 cm⁻¹.

13. The manufacturing method described in (1), wherein the charcoal-based material exhibits the infrared absorption of oxygen(O)-hydrogen(H) stretching at approximately 3000 cm⁻¹.

14. The manufacturing method described in (1), wherein the charcoal-based material exhibits the infrared absorption of carbon(C)-oxygen(O)-carbon(C) stretching in a range of approximately 1000 to 1200 cm⁻¹, the infrared absorption of carbon(C)=carbon(C) symmetric stretching at approximately 1600 cm⁻¹, the infrared absorption of carbon(C)=oxygen(O) stretching at approximately 1700 cm⁻¹, and the infrared absorption of oxygen(O)-hydrogen(H) stretching at approximately 3000 cm⁻¹.

15. The manufacturing method described in (1), wherein at least one type of metal and oxide thereof is added to at least one of the yeast-containing substance, the charcoal-based material, and the electrode material.

16. The manufacturing method described in (7), wherein the oxide is a lower oxide of manganese indicated by the general formula MnO_{y} (where y is the number of oxygen atoms determined by the valence of the manganese (Mn), and is less than 2).

17. An oxygen reduction electrode used for the four-electron reduction of oxygen, which is an electrode that contains a charcoal-based material obtained by carbonizing a yeast-containing substance.

18. The oxygen reduction electrode described in (17), further containing an inorganic compound that contains at least one type of phosphorus (P) and calcium (Ca).

19. The oxygen reduction electrode described in (17), wherein the charcoal-based material exhibits the infrared absorption of carbon(C)-oxygen(O)-carbon(C) stretching in a range of approximately 1000 to 1200 cm⁻¹.

20. The oxygen reduction electrode described in (17), wherein the charcoal-based material exhibits the infrared absorption of carbon(C)=carbon(C) symmetric stretching at approximately 1600 cm⁻¹.

21. The oxygen reduction electrode described in (17), wherein the charcoal-based material exhibits the infrared absorption of carbon(C)=oxygen(O) stretching at approximately 1700 cm⁻¹.

22. The oxygen reduction electrode described in (17), wherein the charcoal-based material exhibits the infrared absorption of oxygen(O)-hydrogen(H) stretching at approximately 3000 cm⁻¹.

23. The oxygen reduction electrode described in (17), wherein the charcoal-based material exhibits the infrared absorption of carbon(C)-oxygen(O)-carbon(C) stretching in a range of approximately 1000 to 1200 cm⁻¹, the infrared absorption of carbon(C)=carbon(C) symmetric stretching at approximately 1600 cm⁻¹, the infrared absorption of carbon(C)=oxygen(O) stretching at approximately 1700 cm⁻¹, and the infrared absorption of oxygen(O)-hydrogen(H) stretching at approximately 3000 cm⁻¹.

24. The oxygen reduction electrode described in (17), further containing at least one type of metal and oxide thereof.

25. The oxygen reduction electrode described in (24), wherein the oxide is a lower oxide of manganese indicated by MnO_{y} (where y is the number of oxygen atoms determined by the valence of the manganese (Mn), and is less than 2).

26. The oxygen reduction electrode described in (17), wherein the charcoal-based material is in powder form, and the electrode material containing the charcoal-based material is supported on an electrically conductive base.

27. The oxygen reduction electrode described in (26), wherein the electrically conductive base is permeable to air.

28. The oxygen reduction electrode described in (17), used for the electrochemical reduction of molecular oxygen in a neutral aqueous electrolyte.

29. An electrochemical element comprising a) a positive electrode for the four-electron reduction of oxygen, b) a negative electrode, and c) an electrolyte; and the positive electrode containing a charcoal-based material obtained by the carbonization of a yeast-containing substance.

30. The electrochemical element described in (29), wherein the positive electrode contains an inorganic compound that contains at least one type of phosphorus (P) and calcium (Ca).

31. The electrochemical element described in (29), wherein the charcoal-based material exhibits the infrared absorption of carbon(C)-oxygen(O)-carbon(C) stretching in a range of approximately 1000 to 1200 cm⁻¹.

32. The electrochemical element described in (29), wherein the charcoal-based material exhibits the infrared absorption of carbon(C)=carbon(C) symmetric stretching at approximately 1600 cm⁻¹.

33. The electrochemical element described in (29), wherein the charcoal-based material exhibits the infrared absorption of carbon(C)=oxygen(O) stretching at approximately 1700 cm⁻¹.

34. The electrochemical element described in (29), wherein the charcoal-based material exhibits the infrared absorption of oxygen(O)-hydrogen(H) stretching at approximately 3000 cm⁻¹.

35. The electrochemical element described in (29), wherein the charcoal-based material exhibits the infrared absorption of carbon(C)-oxygen(O)-carbon(C) stretching in a range of approximately 1000 to 1200 cm⁻¹, the infrared absorption of carbon(C)=carbon(C) symmetric stretching at approximately 1600 cm⁻¹, the infrared absorption of carbon(C)=oxygen(O) stretching at approximately 1700 cm⁻¹, and the infrared absorption of oxygen(O)-hydrogen(H) stretching at approximately 3000 cm⁻¹.

36. The electrochemical element described in (29), wherein the positive electrode contains at least one type of metal and oxide thereof.

37. The electrochemical element described in (36), wherein the oxide is a lower oxide of manganese indicated by MnO_{y} (where y is the number of oxygen atoms determined by the valence of the manganese (Mn), and is less than 2).

38. The electrochemical element described in (29), wherein the charcoal-based material is in powder form, and the electrode material containing the charcoal-based material is supported on an electrically conductive base.

39. The electrochemical element described in (38), wherein the electrically conductive base is gas-permeable.

40. The electrochemical element described in (29), wherein the electrolyte is a neutral aqueous electrolyte.

41. The electrochemical element described in (29), wherein the negative electrode reaction is an oxidation reaction that electrochemically removes electrons from a fuel substance that is soluble in the electrolyte.

42. The electrochemical element described in (29), wherein the electrolyte contains at least one type of sugar and alcohol.

43. A method for the four-electron reduction of oxygen, comprising:
a cell-providing step of providing a cell comprising a) a positive electrode that contains a charcoal-based material obtained by carbonizing a yeast-containing substance, b) a negative electrode and c) an electrolyte; and
an oxygen-supplying step of performing the four-electron reduction of oxygen by supplying oxygen to the positive electrode.

44. The reduction method described in 43), wherein the positive electrode contains an inorganic compound that contains at least one type of phosphorus (P) and calcium (Ca).

45. The reduction method described in (43), wherein the charcoal-based material exhibits the infrared absorption of carbon(C)-oxygen(O)-carbon(C) stretching in a range of approximately 1000 to 1200 cm⁻¹.

46. The reduction method described in (43), wherein the charcoal-based material exhibits the infrared absorption of carbon(C)=carbon(C) symmetric stretching at approximately 1600 cm⁻¹.

47. The reduction method described in (43), wherein the charcoal-based material exhibits the infrared absorption of carbon(C)=oxygen(O) stretching at approximately 2100 cm⁻¹.

48. The reduction method described in (43), wherein the charcoal-based material exhibits the infrared absorption of oxygen(O)-hydrogen(H) stretching at approximately 3000 cm⁻¹.

49. The reduction method described in (43), wherein the charcoal-based material exhibits the infrared absorption of carbon(C)-oxygen(O)-carbon(C) stretching in a range of approximately 1000 to 1200 cm⁻¹, the infrared absorption of carbon(C)=carbon(C) symmetric stretching at approximately 1600 cm⁻¹, the infrared absorption of carbon(C)=oxygen(O) stretching at approximately 2100 cm⁻¹, and the infrared absorption of oxygen(O)-hydrogen(H) stretching at approximately 3000 cm⁻¹.

50. The reduction method described in (43), wherein the positive electrode contains at least one type of metal and oxide thereof.

51. The reduction method described in (50), wherein the oxide is a lower oxide of manganese indicated by MnO_{y} (where y is the number of oxygen atoms determined by the valence of the manganese (Mn), and is less than 2).

52. The reduction method described in (43), wherein the charcoal-based material is in powder form, and the electrode material containing the charcoal-based material is supported on an electrically conductive base to constitute the positive electrode.

53. The reduction method described in (52), wherein the electrically conductive base is gas-permeable.

54. The reduction method described in (43), wherein the electrolyte is a neutral aqueous electrolyte.

55. The reduction method described in (43), wherein the negative electrode reaction is an oxidation reaction that electrochemically removes electrons from a fuel substance that is soluble in the electrolyte.

56. The reduction method described in (43), wherein the electrolyte contains at least one type of sugar and alcohol.

### BRIEF DESCRIPTION OF THE DRAWINGS

FIG. 1 is a diagram depicting the voltage (electromotive force)—current characteristics for the oxygen reduction reactions in test electrodes 1 and 2, and in the comparison electrodes;

FIG. 2 is a diagram depicting the voltage (electromotive force)—current characteristics for the oxygen reduction reactions in test electrodes 3, 4, 5, and 6, and in the comparison electrodes;

FIG. 3 is a cross-sectional view of the tripolar electrode cell measured in Examples of the present invention; and

FIG. 4 is a cross-sectional view of the power-generating cell in another embodiment of the present invention.

Key to Symbols:
1 air electrode
1a air electrode mixture
1b fluororesin porous sheet
1c electrode lead
2 counter electrode
3 reference electrode
4 electrolyte
5 glass cell
6 glass substrate
7 ITO thin film
8 TiO₂ particle thin film
9 dye molecule layer
10 electrolyte/fuel liquid
11 air electrode
12 oxygen-permeable water-repelling layer
13a electrolyte/fuel liquid fill port
13b electrolyte/fuel liquid exhaust port
14a, 14b fluid valve
15 negative electrode lead
16 positive electrode lead
17 seal

### BEST MODE FOR CARRYING OUT THE INVENTION

1. Oxygen Reduction Electrode, and Manufacturing Method Thereof

The oxygen reduction electrode of the present invention is fabricated by a manufacturing method that comprises (1) a first step of obtaining a charcoal-based material by carbonizing a yeast-containing substance, and (2) a second step of manufacturing the electrode by using an electrode material that contains the charcoal-based material.

(1) First Step

In the first step, a charcoal-based material is obtained by carbonizing a yeast-containing substance.

Yeast Type

Aside from yeast itself, the yeast-containing substance may be a yeast-derived substance such as strained yeast lees. These substances may be used singly or as two or more types thereof.

Examples of yeasts that can be used include beer yeast, wine yeast, sake yeast, whisky yeast, bread yeast, feed yeast, and other various types yeast.

Examples of strained lees include strained beer lees, strained sake lees, strained lees of grapes used in wine manufacturing, strained lees of barley used in whisky manufacturing, strained corn lees, soy sauce lees, and the like. When these strained lees are used, effective use of resources, reduction of starting material costs, and other merits are obtained.

Among these yeast-containing substance, those substances are preferred which contain comparatively large quantities of phosphorus and calcium when carbonized. When this type of yeast is used, higher oxygen reducing effects can be obtained. For example, at least one type of beer yeast and strained lees thereof can be used appropriately.

In the present invention, other additives may also be admixed into the yeast-containing substance. The added quantity thereof can be appropriately determined according to the type or other properties of the additive.

For example, an organic binder (polyvinyl alcohol, butyral resin, and the like) or inorganic binder (anhydrous silica and the like) may be added to enhance the manageability of the charcoal-based material.

A solvent may also be admixed into the yeast-containing substance. For example, a phenol or phenol derivative (for example, mononitrophenol, dinitrophenol, trinitrophenol, resorcinol, 1,4-di-hydroxybenzene, m-cresol, p-cresol, or the like) organic solvent may be used.

Carbonization Treatment and Activation Treatment

The charcoal-based material is made by carbonizing the above-mentioned yeast-containing substance. Usually, the charcoal-based material can be obtained by heat-treating the yeast-containing substance. The heat-treatment conditions can be appropriately set according to the composition of the yeast-containing substance used, the properties of the desired charcoal-based material, and the like.

The heat-treating temperature can generally be set in the range of from about 300° C. to about 1200° C. Graphitization progresses if the temperature exceeds 1200° C., so the treatment is preferably performed at a lower temperature. A range of from 500° C. to 1000° C. is more preferred. Better electrical conductivity can be imparted by keeping the temperature at 500° C. or above. Oxygen reducing activity can be imparted and the aforementioned C—O—C bonds for performing the reaction effectively can be left in the carbon component by keeping the temperature at 1000° C. or less.

The heat-treatment time may be appropriately set according to the heat-treatment temperature, type/quantity of the yeast-containing substance used, and the like so that carbonization progresses adequately.

The heat-treatment atmosphere is preferably in a state of low oxygen concentration or in a state in which oxygen is essentially absent so that the yeast is not burned when heating to approximately 300° C. or above. More specifically, an atmosphere is preferably set with an oxygen concentration of 10% by volume or lower, more preferably 1% or lower. Particularly, an inert gas atmosphere (nitrogen, argon, helium, or the like) or a vacuum is preferred.

Activation treatment is preferably performed on the charcoal-based material obtained from carbonization. By means of activation treatment, the specific surface area of the charcoal-based material can be increased and its activity enhanced, the affinity thereof for the reacted substance can be increased, the affinity thereof for other materials when supported can be increased, the degree of surface acidity can be adjusted, and other effects can be obtained.

Activation treatment can be carried out according to a publicly known method. For example, 1) a gas activation method by water vapor, carbon dioxide, or the like or 2) a chemical activation method by ammonium chloride, zinc chloride, potassium hydroxide, or the like may be used. The temperature of activation treatment varies according to the treatment method. For example, a temperature of about the same as in the aforementioned carbonization is preferred for a gas activation method. For a chemical activation process, the treatment can be performed at room temperature or in a range up to about the same temperature as in the carbonization treatment after exposure to an activating agent.

(2) Second Step

In the second step, an electrode is manufactured using an electrode material that contains the charcoal-based material.

Charcoal-Based Material

The charcoal-based material generally contains an organic component having a structure derived from a yeast-containing substance (yeast-type fiber, structure derived from a sugar, or the like).

Particularly, the above-mentioned charcoal-based material preferably exhibits the stretching absorption of carbon(C)-oxygen(O)-carbon(C) at approximately 1100 cm⁻¹ in a wave number range of from 1000 cm⁻¹ to 1200 cm⁻¹ and/or the symmetric stretching absorption of unsaturated carbon(C)=carbon(C) at approximately 1600 cm⁻¹ in the infrared absorption spectrum. This characteristic is not seen in other types of activated carbon, carbon black, and the like, and is specific to the present invention.

It is also not clear from the infrared absorption spectrum whether the charcoal-based material is derived from a carbon component or an inorganic component, but a carbon(C)=oxygen(O) stretching absorption of approximately 1700 cm⁻¹ caused by a carbonyl group having hydrophilic properties and/or an oxygen(O)-hydrogen(H) stretching absorption near approximately 3000 cm⁻¹ caused by a hydroxyl group is preferred.

A more effective contribution can be made to the enhancement of electrode characteristics by using a charcoal-based material that contains components with this type of absorption. The composition of such charcoal-based material generally contains a carbon component and an inorganic component.

The carbon component may be crystalline or non-crystalline, but a non-crystalline carbon component is particularly preferred. It is also generally preferred that the carbon component possess electrical conductivity.

The inorganic component varies according to the composition and the like of the yeast-containing substance used, but generally contains phosphorus (P), calcium (Ca), potassium (K), magnesium (Mg), and the like as a yeast-derived component. A more preferred inorganic component contains P and Ca as main components. These inorganic components may exist in the form of oxides, phosphates, carbonates, or the like. The total content of the inorganic component in the charcoal-based material also varies according to the type and the like of the yeast-containing substance used, but is usually 10% by mass or higher, preferably 20% by mass or higher. This aspect differs from activated carbon, carbon black, and the like in which the total content of inorganic components is a several percent by mass.

The content of the inorganic component is measured as the ash content when the charcoal-based material is put through CHN elemental analysis. The elemental quantity can be measured by X-ray fluorescence elemental analysis, ion chromatography analysis, and the like.

In the present invention, compounds containing these inorganic components can be admixed separately in order to replenish the above-mentioned inorganic component. Particularly, inorganic compounds containing at least one type of phosphorus and calcium can be appropriate for use. One or more types of phosphoric acid, sodium phosphate, potassium phosphate, sodium hydrogen phosphate, calcium hydrogen phosphate, calcium carbonate, calcium oxide, and calcium hydroxide, as well as phosphates, inorganic calcium salts, and the like can be used.

A compound containing the inorganic component may also be admixed into either of the above-mentioned yeast-containing substance or charcoal-based material, but admixture into the yeast-containing substance is particularly preferred.

The form of the charcoal-based material is not limited insofar as it has such properties as described above, but the charcoal-based material is preferably in particle or powder (granular) form. When the charcoal-based material is in granular form, the particle size is preferably such that it can pass through a Tyler sieve of 200 mesh or higher. Furthermore, it is particularly preferred that the maximum particle diameter (diameter) be 20 μm or less, more preferably from 1 μm to 20 μm. The reduction reaction generally occurs on the surface of the particle, so the effectiveness with respect to the quantity used may decline if the diameter exceeds 20 μm. A publicly known grinder, classifier, or the like may be used to adjust the particle size.

Electrode Material

The electrode is fabricated using an electrode material that contains the above-mentioned charcoal-based material. Various materials can be admixed into the electrode material as needed to enhance electrode characteristics and the like. These materials can also be admixed in advance into the yeast-containing substance in a range that does not adversely affect the performance of the present invention.

For example, at least one type of metal and oxide thereof can be admixed therein in order to further raise the ability to take in and release oxygen (oxygen exchange capability). Examples thereof include Mn₂O₃, Mn₃O₄, Mn₅O₈, γ-MnOOH (mixture of Mn₃O₄ with Mn₅O₈), and other lower oxides of manganese MnO_{y} (where y is the number of oxygen atoms determined by the valence of manganese, and is less than 2); ruthenium oxide, Cuₓ₋₁SrₓTiO₃ (x=0 to 0.5), LaₓSr₁₋ₓMnO₃ (x=0 to 0.5), SrTiO₃, and other perovskite oxides; as well as vanadium oxide, platinum black, and the like.

Among these, lower oxides of manganese are preferred for their high hydrogen peroxide decomposition activity, low degradation, and low cost. The term “lower oxide of manganese” refers to a manganese oxide in which the valence of the manganese atom is less than four. This is particularly preferred also from the standpoint of effective use of resources, because the manganese dioxide positive electrode of a used manganese dry cell can be used in unmodified form, or a calcined product may be used, for example.

The added quantity of the above-mentioned metal or an oxide thereof can be appropriately determined according to the type, desired electrode characteristics, and other aspects of the metal or oxide used, but the added quantity is preferably set in a range of 1 wt % to 50 wt %, particularly 5 wt % to 20 wt %, in the electrode ultimately obtained.

Various other additives can also be admixed into the electrode material. Additives can be used, for example, to 1) adjust affinity for another material, 2) adjust the surface (electrode surface) acidity, 3) impart catalytic activity, 4) provide auxiliary catalysis, 5) reduce overvoltage, and for other purposes. Organic materials, inorganic materials, composites thereof, mixtures thereof, and the like can all be used as this type of additive according to the purpose of the additive as described above. More specifically, it is possible to use platinum, cobalt, ruthenium, palladium, nickel, gold, silver, copper, platinum-cobalt alloy, platinum-ruthenium alloy, and other metals or alloys; graphite, activated carbon, and other carbon materials; copper oxides, nickel oxides, cobalt oxides, ruthenium oxides, tungsten oxides, molybdenum oxides, manganese oxides, lanthanum-manganese-copper perovskite oxides, and other metal oxides; iron phthalocyanine, cobalt phthalocyanine, copper phthalocyanine, manganese phthalocyanine, zinc phthalocyanine, and other metal phthalocyanines and metal porphyrins having a porphyrin ring; ruthenium ammine complexes, cobalt ammine complexes, cobalt ethylene diamine complexes, and other metal complexes and the like.

The central metal elements mentioned for the metal complexes are not limiting, but at least one type of platinum, ruthenium, cobalt, manganese, iron, copper, silver, or zinc is particularly preferred. The reduction of oxygen can be accelerated with a smaller overvoltage by using these metal elements. It is also preferred that the valence of the metal element be four or lower. The oxidizing power of the catalyst can be more effectively controlled if the valence is four or lower. As a result, oxidative degradation of the structural elements of the electrochemical element (for example, electrolyte, electrode leads, collector, battery case, separator, gas permselective film, and the like) can be effectively prevented.

The added quantity of the above-mentioned additives can be appropriately determined according to the type of material used, the desired electrode characteristics, and the like, but the added quantity is preferably set in a range of from 1 wt % to 80 wt %, particularly from 20 wt % to 60 wt %, in the electrode ultimately obtained.

The above-mentioned electrode material may contain a material that is commonly added to a publicly known electrode material. For example, polytetrafluoroethylene, Nafion, or other fluororesin binder; polyvinyl alcohol, polyvinyl butyral or other resin binder; graphite, electrically conductive carbon, hydrophilic carbon black, hydrophobic carbon black, or other electrically conductive agent or the like may be appropriately added as necessary.

Electrode Fabrication

The electrode may be manufactured according to a publicly known electrode manufacturing method using the above-mentioned electrode material. For example, fabrication may be carried out by a method whereby a pre-fabricated molding of the electrode material is laminated or pressed onto an electrically conductive base (collector); a method whereby a paste containing the electrode material is coated onto an electrically conductive base; a method whereby an electrically conductive material is mixed with the electrode material and molded; or by another method.

The following materials can be effectively used for the above-mentioned electrically conductive base: carbon paper manufactured from carbon fiber; stainless steel mesh, nickel mesh, or other metal mesh; an electrically conductive composite sheet in which carbon powder, metal powder, or the like is bound by a fluororesin or other synthetic resin binder and machined into a sheet; or the like.

The above-mentioned paste can be obtained by dissolving the binder in an appropriate solvent. For example, when polytetrafluoroethylene is used as the binder, ethanol or another alcohol can be used as the solvent. The concentration of the binder may be appropriately determined according to the type and other attributes of the binder.

Oxygen Reduction Electrode

The present invention also encompasses an oxygen reduction electrode that is obtained by the manufacturing method of the present invention. Specifically, the invention encompasses an electrode that comprises a charcoal-based material obtained by carbonizing a yeast-containing substance, wherein the oxygen reduction electrode is used in the four-electron reduction of oxygen. Consequently, the components described previously may be employed as the yeast-containing substance, charcoal-based material, and other constituent elements in the electrode pertaining to the present invention.

The quantity of the charcoal-based material contained in the oxygen reduction electrode of the present invention is not limited, and may be appropriately determined according to the application, purpose for use, and other aspects of the electrode. Particularly, it is preferable that the electrode contain the charcoal-based material in a ratio of from 1 wt % to 80 wt %, particularly from 20 wt % to 60 wt %. Better four-electron reduction performance can be obtained by setting this content within this range.

The following reactions occur when the oxygen reduction electrode of the present invention is used as the positive electrode of a cell.

In the oxygen reduction electrode of the present invention, the two-electron reduction reaction (1) of oxygen indicated by the formula: O₂+H₂O+2e⁻→OH⁻+HO²⁻ (in an alkaline solution) occurs and hydrogen peroxide is generated (H₂O₂; hydrogen peroxide ion indicated by the formula HO²⁻ in an alkaline solution). Furthermore, the hydrogen peroxide ion thus generated brings about the decomposition reaction (2) indicated by the formula: 2HO²⁻→O₂+2OH⁻, and oxygen is again generated. This oxygen again undergoes two-electron reduction, and a hydrogen peroxide ion is generated.

One molecule of oxygen generates one hydrogen peroxide ionic molecule by the two-electron reduction reaction (1). One molecule of the hydrogen peroxide ion thus generated yields one-half (½) molecule of oxygen by the decomposition reaction (2). The one-half molecule of oxygen generates one-half hydrogen peroxide ionic molecule by the two-electron reduction reaction (1). The one-half peroxide ionic molecule thus generated regenerates one-fourth molecule of oxygen by the decomposition reaction (2). The one-fourth molecule of oxygen generates one-fourth hydrogen peroxide ionic molecule by the two-electron reduction reaction (1). The one-fourth peroxide ionic molecule thus generated yields one-eighth molecule of oxygen by the decomposition reaction (2). The two-electron reduction reaction (1) and decomposition reaction (2) occur repeatedly in this fashion.

Specifically, 2 electrons, 1 electron, ½ electron, ¼ electron, ⅛ electron, . . . , (½)n electron (n→infinity) for a total of 4 electrons are used to reduce one molecule of oxygen, which is essentially the same as one oxygen molecule undergoing four-electron reduction at the potential of a two-electron reduction. In other words, the result is the same as if the reaction were O₂₊₂H₂O+4e⁻→4OH⁻.

Regarding the action of the charcoal-based material of the yeast-containing substance, a four-electron reduction is considered to essentially occur by the repetition of a process whereby a two-electron reduction of an oxygen molecule is brought about by the carbon component, the hydrogen peroxide thus generated is immediately decomposed by the inorganic component, and the resultant oxygen immediately undergoes a further two-electron reduction. This type of reaction is considered to occur due to the extremely close proximity at which the carbon component and the inorganic component are positioned relative to each other. It is considered likely that the phosphorus, calcium, and other elements constituting the main inorganic component mixed with the carbon component have high oxygen exchange capability and that they accelerate the decomposition of hydrogen peroxide, due to having various oxidation states.

It is also believed that the two-electron reduction is accelerated in the vicinity of these carbon components because of high affinity for water in addition to the high affinity for oxygen. Furthermore, the carbon component itself is also considered to efficiently accelerate the reduction reaction because it also has a C—O—C bond, a C═O bond, an OH group, and the like, and high affinity for oxygen, hydrogen peroxide, and water. Silicon and other inorganic components also exist in an oxidized state, and could possibly act as co-catalysts for accelerating the reaction. In any case, four-electron reduction is considered to proceed selectively by means of the synergistic action of these components.

The oxygen reduction electrode of the present invention is thus capable of giving a pathway for the reduction of oxygen to an electrochemical reduction with oxygen as the electrode reacting substance, and initiating a four-electron reduction reaction with high selectivity (selectivity near 100%) by means of the electrochemical catalyst action of a charcoal-based material of a yeast-containing substance.

(2) Electrochemical Element

The electrochemical element of the present invention has a) a positive electrode for the positive electrode reaction in the reduction of oxygen, b) a negative electrode, and c) an electrolyte, wherein the positive element contains a charcoal-based material obtained by the carbonization of a yeast-containing substance.

Specifically, the electrode pertaining to the present invention is basically used as the positive electrode in the electrochemical element of the present invention. Platinum, zinc, magnesium, aluminum, iron, or another publicly known electrode, for example, can be used as the negative electrode.

In the electrochemical element of the present invention, apart from using the oxygen reduction electrode of the present invention as the positive electrode, constituent elements of a publicly known electrochemical element may also be employed. For example, publicly known or commercially available components may be used for the electrolyte, separator, vessel, electrode leads, and the like.

Particularly, the electrolyte may consist of either an electrolyte solution or a solid electrolyte, but the use of an electrolyte solution is particularly appropriate. When an electrolyte solution is used, its solvent may consist of either water or an organic solvent. An aqueous solution is preferably used as the electrolyte solution. The pH of the electrolyte solution is not limited, but a neutral range from pH 6 to pH 9 is particularly preferred. Use of a neutral aqueous solution as the electrolyte is preferred in the present invention because higher activity is thereby obtained.

The electrolyte preferably contains a fuel substance. It is particularly preferred that the fuel substance be dissolved in the neutral aqueous solution. The negative electrode reaction at this time preferably consists of an oxidation reaction that electrochemically removes one or more electrons from the fuel substance dissolved in the electrolyte. The above-mentioned fuel substance is not particularly limited insofar as it is soluble in the electrolyte used (particularly in a neutral aqueous solution), but preferably consists of at least one type of sugar or alcohol. Examples of sugars include glucose, fructose, mannose, starch, cellulose, and the like. Examples of alcohols include methanol, ethanol, propanol, butanol, glycerol, and the like.

The content (concentration) of the fuel substance in the electrolyte depends on the type of fuel used, the type of solvent, and other aspects, but a content of about 0.01 wt % to about 100 wt %, particularly 1 wt % to 20 wt %, is generally preferred.

In the electrochemical element of the present invention, the electrode is preferably placed and used in a location in which contact is established between three phases consisting, for example, of 1) a gas containing oxygen, 2) a liquid composed of an electrolyte solution, and 3) a solid composed of an electrical conductor. By placing the electrode of the present invention (particularly the yeast charcoal-based material) at the intersection of the ion path and the electron path, it becomes possible to smoothly induce electrochemical reduction of oxygen at a small overvoltage (resistance), and a large current value can be obtained.

The oxygen reduction electrode of the present invention has almost no oxidizing activity with respect to the sugar or alcohol that is the electrolyte-soluble fuel. A power-generating cell can therefore be constructed by using the electrode of the present invention as the plus terminal (positive electrode), a solution of a sugar or an alcohol as the electrolyte, and a minus terminal (negative electrode) for oxidizing the sugar or alcohol. In this case, even if the positive electrode side is not isolated from the negative electrode side by a separator, the voltage of the power-generating cell does not decline even if the sugar or alcohol that is the fuel dissolved in the electrolyte comes into direct contact with the positive electrode. A separator may, of course, be used as needed in the electrochemical element of the present invention.

A four-electron reduction of oxygen such as was described previously is initiated because an electrode containing a charcoal-based material obtained from the carbonization of a yeast-containing substance is used as the positive electrode in the electrochemical element of the present invention. In other words, a four-electron reduction reaction can be performed by using the electrochemical element of the present invention.

### ADVANTAGES OF THE INVENTION

According to the electrode of the present invention, an electrode can be obtained that is capable of efficient electrochemical reduction of oxygen by using a charcoal-based material of a yeast-containing substance.

Specifically, the electrode of the present invention demonstrates substantial four-electron reduction effects that have heretofore not been known in a conventional carbon material for catalyzing the two-electron reduction of an oxygen molecule.

By placing the electrode of the present invention at the intersection of the ion path and the oxygen path, it becomes possible to smoothly induce electrochemical reduction of oxygen at a small overvoltage (resistance). As a result, an electrochemical element can be provided that is capable of yielding a large electromotive force and a large current value.

Particularly, the electrode of the present invention becomes a substitute for platinum and other noble metal catalysts that constitute the conventional four-electron reduction catalysts, because the reduction of oxygen molecules essentially progresses with four electrons. It thereby becomes possible to provide an electrode that achieves all of the following advantages: 1) low cost; 2) no need to use a separator to divide the locations at which oxidation and reduction reactions are performed; 3) control over catalyst inactivation due to poisoning or the like; and other effects.

By using a charcoal-based material obtained by carbonizing a yeast-containing substance as the support for the catalyst in the redox electrode, it also becomes possible to reduce the quantity of platinum and other noble metal catalysts used, because the reduction reaction is electrochemically catalyzed by the carrier itself.

Furthermore, it is considered likely that functions will be retained whereby reduction in performance due to poisoning and the like of platinum or other noble metal catalysts is minimized, and it becomes possible to achieve an even better performance.

### INDUSTRIAL APPLICABILITY

By means of the present invention, a highly stable oxygen reduction electrode that allows four-electron reduction to occur with a selectivity of about 100% in practical terms can be provided for the electrochemical reduction of oxygen. This type of oxygen reduction electrode can be used for the air electrode, oxygen electrode, or other component of an electrochemical element in which an oxygen reduction reaction occurs as the positive electrode reaction. For example, this electrode can be appropriately used in a zinc-air battery, aluminum-air battery, sugar-air battery, or other air battery; an oxygen hydrogen fuel cell, methanol fuel cell, or other fuel cell; an enzyme sensor, oxygen sensor, or other electrochemical sensor; or the like.

The electrode and manufacturing method of the present invention as described above are suitable for industrial-scale production, and are highly practical.

### EXAMPLES

The present invention will be described in further detail hereinafter using examples and comparative examples. However, the scope of the present invention is not limited by these embodiments.

### Example 1

Fabrication of Test Electrodes 1 and 2

Strained beer lees containing beer yeast were carbonized in a nitrogen atmosphere at 800° C., and test electrodes 1 and 2 were fabricated using a charcoal-based material obtained by performing water vapor activation at 900° C.

The solid carbon content in the resultant charcoal-based material was approximately 64% by mass. The ash content as measured by elemental analysis was approximately 30% by mass. It was apparent from elemental analysis by X-ray fluorescence that phosphorus (P) accounted for approximately 30% by mass, calcium (Ca) was 23% by mass, magnesium (Mg) was 7% by mass, potassium (K) was 3% by mass, and silicon (Si) was approximately 20% by mass, and that P and Ca were the main components. Observation of characteristic absorptions in the infrared spectrum also showed C—O—C absorption having an absorption peak at a wave number of approximately 1110 cm⁻¹, C═C absorption having an absorption peak at approximately 1570 cm⁻¹, C═O absorption having an absorption peak at approximately 1705 cm⁻¹, and broad O-H absorption near 3000 cm⁻¹. These absorptions are not for perfect charcoal-based materials consisting only of carbon, but are derived from the molecular structure of a yeast-containing uncarbonized substance.

The charcoal-based material thus obtained was pulverized to obtain a powder having a maximum particle diameter of 10 μm or less. 25 μg of this powder were dispersed in 5 μL of an ethanol solution in which 0.05% by mass of proton-conductive Nafion (product name: “Nafion 112,” manufactured by DuPont, same hereinafter) was dissolved. A test electrode containing the charcoal-based material and Nafion was fabricated by a process whereby the resultant dispersion was dripped onto a gas-permeable electrically conductive base so as to completely cover the surface thereof, the product was dried in hot air to vaporize the ethanol, the same dispersion was again dripped thereon, and the ethanol was again vaporized.

Carbon paper (product name: “TGPH-120,” manufactured by Toray, same hereinafter) with a thickness of 0.36 mm was used as the gas-permeable electrically conductive base. A waterproof carbon paper base obtained by retaining a mixture composed of 1 weight part of powdered carbon black and 0.1 weight part of polytetrafluoroethylene (PTFE) binder on the carbon paper to a coverage of 2.25 mg/cm² and a carbon paper base with no waterproofing treatment were used.

Test electrode 1 was obtained in which the charcoal-based material was coated onto the surface of the waterproof carbon paper base by the aforementioned method so as to give a coverage of 4.2 mg/cm². Test electrode 2 was also obtained in which the charcoal-based material was coated onto the carbon paper base so as to give a coverage of 2 mg/cm².

### Example 2

Fabrication of Test Electrode 3

Strained beer lees containing beer yeast were carbonized in a nitrogen atmosphere at 800° C., and water vapor activation was performed at 900° C. 4 weight parts of the resultant charcoal-based material (average particle diameter: approximately 5 μm), 4 weight parts of a lower oxide of manganese (a mixture of Mn₃O₄ and Mn₅O₈; average particle diameter of approximately 10 μm), 1 weight part of carbon black, and 0.2 weight part of fluororesin binder (PTFE) were mixed. A sheet was fabricated from this mixture using a gas-permeable electrically conductive base made of a nickel-plated stainless steel mesh (thickness of 0.15 mm; 25 mesh) as a core. A fluororesin porous sheet (porosity: approximately 50%; thickness: 0.2 mm) was then pressed onto one side of this sheet and test electrode 3 with a thickness of approximately 3 mm was fabricated.

### Example 3

Fabrication of Test Electrode 4

5 weight parts of beer yeast and 0.1 weight part of calcium hydrogen phosphate were mixed into 0.1 weight part of an anhydrous silicate binder, and the product was mold-cured. The resultant mixture was carbonized in a nitrogen atmosphere at 900° C. The resultant charcoal-based material was pulverized to a maximum diameter of 20 μm or less. 25 μg of the resultant powder were dispersed in 5 μL of an ethanol solution in which 0.05% by mass of Nafion was dissolved. Test electrode 4 containing the charcoal-based material and Nafion was fabricated by a process whereby the dispersion was dripped onto the waterproofed carbon paper base used in Example 1 so as to completely cover the surface thereof, the product was dried in hot air, and the ethanol was again vaporized. The electrode was also formed to give a charcoal-based material coverage of 2 mg/cm².

### Example 4

Fabrication of Test Electrode 5

Strained beer lees containing beer yeast were carbonized in a nitrogen atmosphere at 800° C., and water vapor activation was performed at 900° C. to obtain a charcoal-based material. This charcoal-based material was pulverized to a maximum diameter of 10 μm or less. The resultant powder was impregnated with a 3-mmol/L ethanol solution of chloroplatinic acid to form a platinum salt. Sodium borohydride was added to the product at room temperature and reduced, and the platinum was supported. The ratio of supported platinum at this time was approximately 10% by mass. 25 μg of charcoal-based material to which this platinum was added were dispersed in 5 μL of an ethanol solution in which 0.05% by mass of proton-conductive Nafion was dissolved. Test electrode 5 containing the charcoal-based material and Nafion was fabricated by a process whereby the dispersion was dripped onto the waterproof carbon paper base used in Example 1 so as to completely cover the surface thereof, the product was dried in hot air to vaporize the ethanol, the same dispersion was again dripped thereon, and the ethanol was again vaporized. The charcoal-based material was formed into a coverage of 2 mg/cm², and the platinum content at this time was approximately 0.2 mg/cm² in test electrode 5.

### Example 5

Fabrication of Test Electrode 6

Strained lees of barley used in whisky manufacturing containing yeast were carbonized in a nitrogen atmosphere at 800° C., the product was water vapor activated at 900° C., and test electrode 6 was fabricated using the resultant charcoal-based material. The charcoal-based material was pulverized to a maximum diameter of 10 μm or less. 25 μg of this powder were dispersed in 5 μL of an ethanol solution in which 0.05% by mass of proton-conductive Nafion was dissolved. Test electrode 6 containing the charcoal-based material and Nafion was fabricated by a process whereby the dispersion was dripped onto a gas-permeable electrically conductive base made of carbon paper with a thickness of 0.36 mm so as to completely cover the surface thereof, the product was dried in hot air to vaporize the ethanol, the same dispersion was again dripped thereon, and the ethanol was again vaporized. The charcoal-based material was supported on the carbon paper base to the extent of 2 mg/cm².

### Comparative Example 1

Fabrication of Comparison Electrodes 1, 2, 3, 4, and 5

25 μg of powdered carbon black with a platinum support ratio of 50% by mass were dispersed in 5 μL of an ethanol solution in which 0.05% by mass of proton-conductive Nafion was dissolved. Comparison electrode 1 with a platinum content of approximately 0.35 mg/cm² was fabricated by a process whereby the dispersion was dripped onto a waterproof carbon paper base with a thickness of 0.36 mm obtained by retaining a mixture composed of 1 weight part of powdered carbon black and 0.1 weight part of polytetrafluoroethylene (PTFE) binder on the carbon paper to a coverage of 2.25 mg/cm². The product was dried in hot air to vaporize the ethanol, the same dispersion was again dripped thereon, and the ethanol was again vaporized.

At that time, comparison electrode 2 with a platinum content of approximately 0.2 mg/cm² was fabricated by performing the same process, except that powdered carbon black with a platinum support ratio of 30% by mass was used instead of the powdered carbon black described above.

Comparison electrode 3 was also fabricated using the waterproof carbon paper base described above; comparison electrode 4 was fabricated using carbon paper only; and comparison electrode 5 was fabricated with an ethanol solution of proton-conductive Nafion containing none of the charcoal-based material described above formed on a carbon paper base.

### Example 6

Evaluation of Electrode Characteristics of Test Electrodes 1 and 2

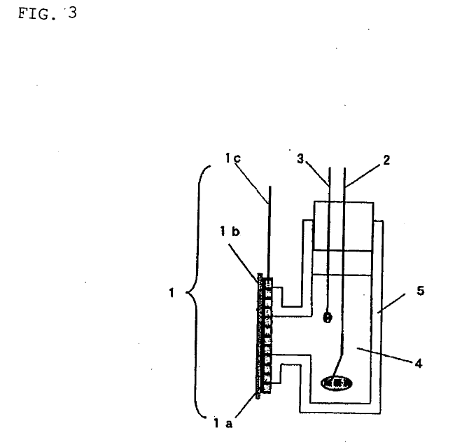

A tripolar cell having the structure depicted in FIG. 3 was assembled and the oxygen reduction properties in the test electrodes were evaluated as voltage-current characteristics. In FIG. 3, 1 is an air electrode, 1a is a test electrode or comparison electrode; 1b is a fluororesin porous sheet; 1c is an electrode lead; 2 is a counter electrode; 3 is a reference electrode; 4 is an electrolyte; and 5 is a glass cell that has an opening 16 mm in diameter for positioning an air electrode. The air electrode 1 is disposed so that the surface next to the fluororesin porous sheet 1b is exposed to the atmosphere at the opening of the glass cell 5 as shown in FIG. 3, and the other surface is in contact with the electrolyte 4. A 0.1-M phosphoric acid buffer solution at pH 7.0 was used as the electrolyte 4. Platinum was used as the counter electrode 2, and an Ag/AgCl (saturated KCl) electrode was used as the reference electrode 3. The test electrode or comparison electrode 1a was also affixed to the fluororesin porous sheet 1b.

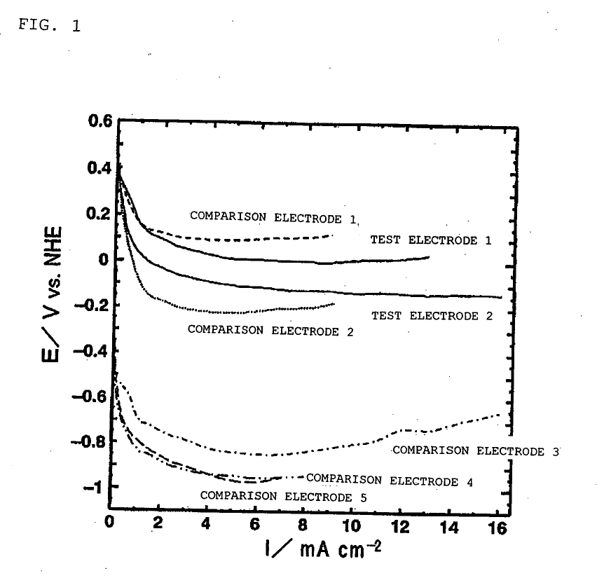

The voltage-current characteristics when the test electrodes 1 and 2 and the comparison electrodes were used for the air electrode 1 are compared in FIG. 1. Measurement was performed with the applied current maintained for at least 10 minutes, and the electromotive force was corrected for the cell resistance and displayed based on the normal hydrogen electrode (NHE). Small overvoltage and high electromotive force were obtained with test electrodes 1 and 2 compared with the carbon black comparison electrode 3, and about the same electromotive force was obtained with comparison electrodes 1 and 2, which had platinum catalysts. The reason for this is considered to be that the charcoal-based material used in the test electrodes essentially performs four-electron reduction, so characteristics are obtained that match the four-electron reduction effected by platinum, in contrast with the two-electron reduction of oxygen by the conventional carbon material.

### Example 7

Evaluation of Electrode Characteristics of Test Electrodes 3, 4, 5, and 6

A tripolar cell with the structure depicted in FIG. 3 was assembled in the same manner as in Example 6, and the oxygen reduction properties in the test electrodes were evaluated according to voltage-current characteristics.

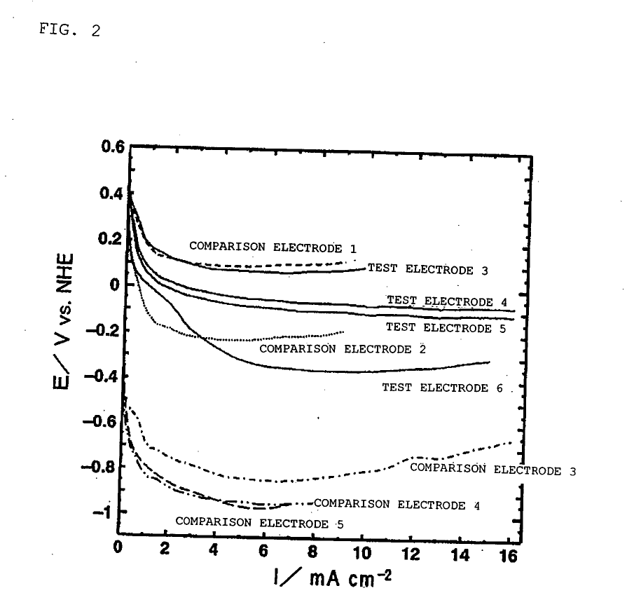

The voltage-current characteristics when the test electrodes 3, 4, 5, and 6 and the comparison electrodes were used for the air electrode 1 are compared in FIG. 2. The same as in Example 6, small overvoltage and high electromotive force were obtained in the test electrodes compared with the carbon black comparison electrode 3, and it was apparent that the reduction of oxygen was catalyzed to near four-electron reduction.

In test electrode 3, the lower oxide of manganese contained in the air electrode had strong decomposing effects on the hydrogen peroxide generated by the two-electron reduction of oxygen molecules, so substantial four-electron reducing effects were high and virtually the same electromotive force was obtained as in the platinum comparison electrode 1.

In test electrode 4, high electromotive force was obtained as an electrochemical catalysis effect by the powder in the mold-cured charcoal-based material. Because of this, it was possible to form the charcoal-based material into an electrode without preparing a powder, thus leading to enhanced manageability.

In test electrode 5, high electromotive force was obtained compared with the comparison electrode 2 in which the quantity of platinum deposited on the charcoal-based material was the same. This is because the reducing action of a charcoal-based material obtained by adding platinum and carbonizing yeast is combined to give an efficient reduction reaction. It becomes possible to reduce the consumption of high-cost noble metal catalyst by using this charcoal-based material as a catalyst support.

When the retention time of the electromotive force in the air electrode that used test electrode 5 was compared with comparison electrode 1, it was confirmed that five times longer retention was achieved by test electrode 5 than comparison electrode 1 in the time required for the electromotive force to decrease 10%. A major factor that contributes to this decrease in electromotive force is poisoning of the platinum catalyst. There was a slight decline in electromotive force in test electrode 5 because of the low platinum content, but due to the existence of other effects more significant than a simple difference in the platinum content ((test electrode 5):(comparison electrode 1)=0.2:0.35), this effect cannot be explained solely by poisoning, and other effects are considered to contribute. The other effects are unclear, but owing to effects whereby the charcoal-based material accelerates the essential four-electron reduction of oxygen, this action is thought to have the effect of minimizing poisoning of the platinum.

In test electrode 6, it was apparent that the same four-electron reduction effects were also obtained with a charcoal-based material derived from a yeast other than beer yeast.

### Example 8

Evaluation of Power-Generating Cell Characteristics

Power-generating cell a was configured with the air electrode comprising the test electrode 1 of Example 1 as the plus terminal (positive electrode), the platinum of the opposing terminal as the minus terminal (negative electrode), and a 0.1-M phosphoric acid buffer solution at pH 6.8 with glucose dissolved therein to a concentration of 100 mM as the electrolyte. Power-generating cell b was configured using the same positive electrode and negative electrode as the power-generating cell a, and with a 0.1-M phosphoric acid buffer solution at pH 6.8 with methanol dissolved therein to a concentration of 3% by mass as the electrolyte. Power-generating cell c and power-generating cell d were also configured with the same structure, except that an air electrode with a platinum plate Pt was used as the positive electrode. The open-circuit voltages of the power-generating cells and the voltages after discharging the cells for ten hours at a constant current of 1 mA are shown in Table 1.

TABLE 1

| | | | Open- | Voltage after |
|---|---|---|---|---|
| Power- | | | circuit | 10-hour |
| generating | Plus | | voltage | discharge |
| cell | terminal | Fuel | (volts) | (volts) |
| a | Air | Glucose | 0.86 | 0.78 |
| | electrode | | | |
| b | Air | Methanol | 0.72 | 0.66 |
| | electrode | | | |
| c | Platinum | Glucose | 0.43 | 0.28 |
| | plate | | | |
| d | Platinum | Methanol | 0.33 | 0.28 |
| | plate | | | |

Discharge voltages that were 0.2 to 0.4 V higher compared with the power-generating cells c and d, in which a platinum plate was used for the plus-terminal, were obtained in the power-generating cells a and b, in which an air electrode that contained the charcoal-based material of the present invention as the active component was used for the plus-terminal. These results demonstrate that the power-generating cells in question produce a high voltage because a plus-terminal consisting of an air electrode that contains a carbonized beer yeast charcoal-based material as the active component thereof generates an electrical potential that is determined by the reduction of oxygen without causing an oxidation reaction even when in direct contact with glucose or methanol. In contrast, because a plus-terminal made of a platinum plate causes an oxidation reaction when in direct contact with glucose or methanol, the corresponding power-generating cell is considered to produce a low voltage due to the low electrical potential determined by the oxidation of glucose or methanol and the reduction of oxygen.

Glucose and methanol were used as fuel substances that are soluble in the electrolyte, but the same effects are obtained using sugars other than glucose (fructose, mannose, starch, cellulose, and the like) and alcohols other than methanol (ethanol, propanol, butanol, glycerol, and the like). The same effects are also obtained using a 0.1-N KOH solution or saline in which 3% by mass of NaCl is dissolved as the electrolyte, instead of a 0.1-M phosphoric acid buffer solution with a pH of 6.8.

### Example 9

Assembly of Power-Generating Cell

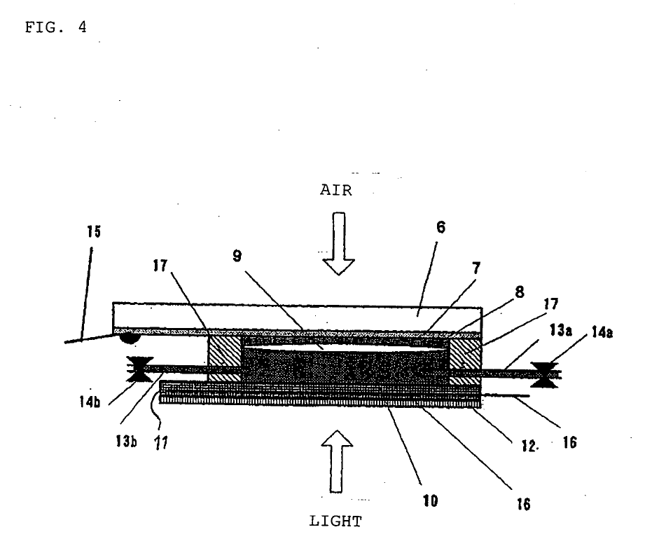

Power-generating cells A and B were assembled with the structure depicted in FIG. 4.

The air electrode 11 used as the positive electrode in FIG. 4 was fabricated for the power-generating cell A using the test electrode 1 obtained in Example 1. In FIG. 4, 15 is the negative electrode lead, 16 is the positive electrode lead, and 17 is a seal made of silicone rubber.

The photocatalyst electrode used as the negative electrode in FIG. 4 is composed of a glass base 6, an ITO thin film 7, a titanium oxide (TiO₂) particle film 8, and a dye molecule layer 9. A light-transmissive, electrically conductive base plate was provided. The plate was produced by forming an indium tin oxide (ITO) thin film 7 with a surface resistance of 10 Ω/cm² on a glass base 6 with a thickness of 1 mm. An acetonitrile solution containing 30% by mass of polyethylene glycol with 11% by mass of TiO₂ particles having an average particle diameter of 10 nm dispersed therein was coated onto the ITO thin film by an impregnation method, the coating was dried at 80° C., and a TiO₂ particle film 8 having a thickness of approximately 10 μm was formed by baking the product in a vacuum at 400° C. for one hour. Dye molecules 9 were then deposited onto the TiO₂ particle film 8 by immersing the TiO₂ particle film in ethanol in which ruthenium metal complex dye molecules 9 as follows were dissolved at a concentration of 10 mM. The above-mentioned photocatalyst electrode was then fabricated by a process whereby the product was immersed in 4-tert-butyl pyridine, rinsed with acetonitrile, and dried.

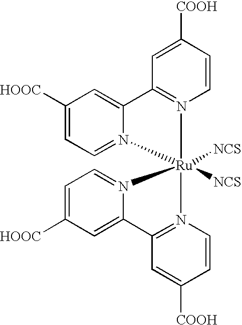

A product obtained by dissolving 5% by mass of fuel methanol, 5 mM nicotinamide nucleotide (NADH) coenzyme, 16.0 U/mL of alcohol dehydrogenase (ADH), 1.0 U/mL of aldehyde dehydrogenase (AlDH), and 0.3 U/mL of formate dehydrogenase (FDH) in a 0.1-M phosphoric acid buffer solution with a pH of 7.0 was used as the electrolyte solution/fuel solution 10. The electrolyte solution/fuel solution 10 was injected from the electrolyte solution/fuel solution fill port 13a and discharged from the discharge port 13b after electrical generation. Air was supplied to the inside of the power-generating cell from the outside through the oxygen-permeable water-repelling film 12.

The structure of the power-generating cell depicted in FIG. 4 will next be described. The negative electrode side of this power-generating cell was primarily composed of the glass base 6, and the ITO thin film 7 was laminated onto the surface of the glass base 6. The negative electrode lead 15 was provided to the ITO thin film 7. The positive electrode side of the power-generating cell was primarily composed of the plate-shaped air electrode 11, and the oxygen-permeable water-repelling film 12 was laminated onto the surface of the air electrode 11. The positive electrode lead 16 extended from inside the air electrode 11. The power-generating cell was formed by bringing the surface of this type of glass base 6 to face the back surface of the plate-shaped air electrode 11, and fixing the glass base 6 and the air electrode 11 together with the seal 17 between them.

In the space between the glass base 6 and the air electrode 11, the electrolyte solution (or fuel solution) 10 was positioned next to the air electrode 11, and a particle thin film 8 in which particles consisting of titanium oxide were dispersed was positioned next to the glass base 6. The dye separation layer 9 was also sandwiched between the electrolyte solution (or fuel solution) 10 and the particle thin film 8.

An electrolyte solution/fuel solution fill port 13a and electrolyte solution/fuel solution discharge port 13b passing through the seal 17 were also provided to the seal 17. Fluid valves 14a and 14b were provided to the electrolyte solution/fuel solution fill port 13a and electrolyte solution/fuel solution discharge port 13b, respectively. A configuration was adopted whereby the electrolyte solution (or fuel solution) 10 between the glass base 6 and air electrode 11 could be injected from the outside and discharged to the outside via the electrolyte solution/fuel solution fill port 13a and electrolyte solution/fuel solution discharge port 13b.

Power-generating cell B was also fabricated so as to have the same structure as power-generating cell A, except that power-generating cell B used an air electrode fabricated using the test electrode 3 obtained in Example 2.

Operating Characteristics of the Power-Generating Cells

After filling the power-generating cells with electrolyte solution/fuel solution, the cells were irradiated from the glass base 6 side with light of a sunlight simulator (AM 1.5, 100 mW/cm²), and the electromotive force (Open Circuit Voltage; OCV) and voltage of the power-generating cells after discharge at a constant current of 100 μA for 20 minutes were measured. The OCV was 0.80 V in power-generating cell A and 0.65 V in power-generating cell B. The voltages of the power-generating cells after a 20-minute discharge were 0.75 V in power-generating cell A and 0.55 V in power-generating cell B. Thus, high electromotive force was obtained and high voltage was maintained even during discharge.

A battery comprising a photocatalyst electrode as the negative electrode of the power-generating cell and methanol as fuel is described in the present example, but even when zinc, magnesium, aluminum, or another metal is used as the negative electrode, a battery can be obtained as an electrochemical element having high electromotive force and high cell voltage during discharge by combining the negative electrode of the above metals with the oxygen reduction electrode according to the present invention.

1. A method for manufacturing an oxygen reduction electrode used in the four-electron reduction of oxygen, the manufacturing method comprising (1) a first step of obtaining a charcoal-based material by carbonizing a yeast-containing substance, and (2) a second step of manufacturing the oxygen reduction electrode using an electrode material that contains the charcoal-based material.

2. The manufacturing method according to claim 1, wherein the yeast-containing substance is at least one type of beer yeast, wine yeast, sake yeast, whisky yeast, bread yeast, feed yeast, strained beer lees, sake lees, strained lees of grapes used in wine manufacturing, strained lees of barley used in whisky manufacturing, strained corn lees, and soy sauce lees.

3. The manufacturing method according to claim 1, wherein the yeast-containing substance is carbonized at a temperature of from 300° C. to 1200° C. in an atmosphere in which the oxygen concentration is 10% or less by volume in the first step.

4. The manufacturing method according to claim 3, wherein the yeast-containing substance is carbonized at a temperature of from 500° C. to 1000° C. in an atmosphere in which the oxygen concentration is 10% or less by volume in the first step.

5. The manufacturing method according to claim 3, wherein the atmosphere is an inert gas atmosphere.

6. The manufacturing method according to claim 1, wherein the charcoal-based material is further activated in the first step.

7. The manufacturing method according to claim 1, wherein the oxygen reduction electrode is manufactured in the second step by forming the electrode material into a prescribed shape to obtain a molded article, and laminating or pressure-bonding the molded article to an electrically conductive base.

8. The manufacturing method according to claim 1, wherein the oxygen reduction electrode is manufactured in the second step by preparing a paste containing the electrode material, and coating the paste onto an electrically conductive base.

9. The manufacturing method according to claim 1, wherein an inorganic compound containing at least one type of phosphorus (P) and calcium (Ca) is added to at least one of the yeast-containing substance, the charcoal-based material, and the electrode material.

10. The manufacturing method according to claim 1, wherein the charcoal-based material exhibits the infrared absorption of carbon(C)-oxygen(O)-carbon(C) stretching in a range of approximately 1000 to 1200 cm⁻¹.

11. The manufacturing method according to claim 1, wherein the charcoal-based material exhibits the infrared absorption of carbon(C)=carbon(C) symmetric stretching at approximately 1600 cm⁻¹.

12. The manufacturing method according to claim 1, wherein the charcoal-based material exhibits the infrared absorption of carbon(C)=oxygen(O) stretching at approximately 1700 cm⁻¹.

13. The manufacturing method according to claim 1, wherein the charcoal-based material exhibits the infrared absorption of oxygen(O)-hydrogen(H) stretching at approximately 3000 cm⁻¹.

14. The manufacturing method according to claim 1, wherein the charcoal-based material exhibits the infrared absorption of carbon(C)-oxygen(O)-carbon(C) stretching in a range of approximately 1000 to 1200 cm⁻¹, the infrared absorption of carbon(C)=carbon(C) symmetric stretching at approximately 1600 cm⁻¹, the infrared absorption of carbon(C)=oxygen(O) stretching at approximately 1700 cm⁻¹, and the infrared absorption of oxygen(O)-hydrogen(H) stretching at approximately 3000 cm⁻¹.

15. The manufacturing method according to claim 1, wherein at least one type of metal and oxide thereof is added to at least one of the yeast-containing substance, the charcoal-based material, and the electrode material.

16. The manufacturing method according to claim 7, wherein the oxide is a lower oxide of manganese indicated by the general formula MnO_{y}, wherein y is the number of oxygen atoms determined by the valence of the manganese (Mn), and is less than 2.

17. An oxygen reduction electrode used for the four-electron reduction of oxygen, wherein the electrode comprises a charcoal-based material obtained by carbonizing a yeast-containing substance.

18. The oxygen reduction electrode according to claim 17, which further comprises an inorganic compound that contains at least one type of phosphorus (P) and calcium (Ca).

19. The oxygen reduction electrode according to claim 17, wherein the charcoal-based material exhibits the infrared absorption of carbon(C)-oxygen(O)-carbon(C) stretching in a range of approximately 1000 to 1200 cm⁻¹.

20. The oxygen reduction electrode according to claim 17, wherein the charcoal-based material exhibits the infrared absorption of carbon(C)=carbon(C) symmetric stretching at approximately 1600 cm⁻¹.

21. The oxygen reduction electrode according to claim 17, wherein the charcoal-based material exhibits the infrared absorption of carbon(C)=oxygen(O) stretching at approximately 1700 cm⁻¹.

22. The oxygen reduction electrode according to claim 17, wherein the charcoal-based material exhibits the infrared absorption of oxygen(O)-hydrogen(H) stretching at approximately 3000 cm⁻¹.

23. The oxygen reduction electrode according to claim 17, wherein the charcoal-based material exhibits the infrared absorption of carbon(C)-oxygen(O)-carbon(C) stretching in a range of approximately 1000 to 1200 cm⁻¹, the infrared absorption of carbon(C)=carbon(C) symmetric stretching at approximately 1600 cm⁻¹, the infrared absorption of carbon(C)=oxygen(O) stretching at approximately 1700 cm⁻¹, and the infrared absorption of oxygen(O)-hydrogen(H) stretching at approximately 3000 cm⁻¹.

24. The oxygen reduction electrode according to claim 17, which further comprises at least one type of metal and oxide thereof.

25. The oxygen reduction electrode according to claim 24, wherein the oxide is a lower oxide of manganese indicated by MnO_{y}, wherein y is the number of oxygen atoms determined by the valence of the manganese (Mn), and is less than 2.

26. The oxygen reduction electrode according to claim 17, wherein the charcoal-based material is in powder form, and the electrode material containing the charcoal-based material is supported on an electrically conductive base.

27. The oxygen reduction electrode according to claim 26, wherein the electrically conductive base is gas-permeable.

28. The oxygen reduction electrode according to claim 17, which is used for the electrochemical reduction of molecular oxygen in a neutral aqueous electrolyte.

29. An electrochemical element comprising a) a positive electrode for the four-electron reduction of oxygen, b) a negative electrode, and c) an electrolyte, wherein the positive electrode comprises a charcoal-based material obtained by the carbonization of a yeast-containing substance.

30. The electrochemical element according to claim 29, wherein the positive electrode comprises an inorganic compound that contains at least one type of phosphorus (P) and calcium (Ca).

31. The electrochemical element according to claim 29, wherein the charcoal-based material exhibits the infrared absorption of carbon(C)-oxygen(O)-carbon(C) stretching in a range of approximately 1000 to 1200 cm⁻¹.

32. The electrochemical element according to claim 29, wherein the charcoal-based material exhibits the infrared absorption of carbon(C)=carbon(C) symmetric stretching at approximately 1600 cm⁻¹.

33. The electrochemical element according to claim 29, wherein the charcoal-based material exhibits the infrared absorption of carbon(C)=oxygen(O) stretching at approximately 1700 cm⁻¹.

34. The electrochemical element according to claim 29, wherein the charcoal-based material exhibits the infrared absorption of oxygen(O)-hydrogen(H) stretching at approximately 3000 cm⁻¹.

35. The electrochemical element according to claim 29, wherein the charcoal-based material exhibits the infrared absorption of carbon(C)-oxygen(O)-carbon(C) stretching in a range of approximately 1000 to 1200 cm⁻¹, the infrared absorption of carbon(C)=carbon(C) symmetric stretching at approximately 1600 cm⁻¹, the infrared absorption of carbon(C)=oxygen(O) stretching at approximately 1700 cm⁻¹, and the infrared absorption of oxygen(O)-hydrogen(H) stretching at approximately 3000 cm⁻¹.

36. The electrochemical element according to claim 29, wherein the positive electrode contains at least one type of metal and oxide thereof.

37. The electrochemical element according to claim 36, wherein the oxide is a lower oxide of manganese indicated by MnO_{y}, wherein y is the number of oxygen atoms determined by the valence of the manganese (Mn), and is less than 2.

38. The electrochemical element according to claim 29, wherein the charcoal-based material is in powder form, and the electrode material containing the charcoal-based material is supported on an electrically conductive base.

39. The electrochemical element according to claim 38, wherein the electrically conductive base is gas-permeable.

40. The electrochemical element according to claim 29, wherein the electrolyte is a neutral aqueous electrolyte.

41. The electrochemical element according to claim 29, wherein the negative electrode reaction is an oxidation reaction that electrochemically removes electrons from a fuel substance that is soluble in the electrolyte.

42. The electrochemical element according to claim 29, wherein the electrolyte contains at least one type of sugar and alcohol.

43. A method for the four-electron reduction of oxygen, comprising:
a cell-providing step of providing a cell comprising a) a positive electrode that contains a charcoal-based material obtained by carbonizing a yeast-containing substance, b) a negative electrode and c) an electrolyte; and
an oxygen-supplying step of performing the four-electron reduction of oxygen by supplying oxygen to the positive electrode.

44. The reduction method according to claim 43, wherein the positive electrode contains an inorganic compound that contains at least one type of phosphorus (P) and calcium (Ca).

45. The reduction method according to claim 43, wherein the charcoal-based material exhibits the infrared absorption of carbon(C)-oxygen(O)-carbon(C) stretching in a range of approximately 1000 to 1200 cm⁻¹.

46. The reduction method according to claim 43, wherein the charcoal-based material exhibits the infrared absorption of carbon(C)=carbon(C) symmetric stretching at approximately 1600 cm⁻¹.

47. The reduction method according to claim 43, wherein the charcoal-based material exhibits the infrared absorption of carbon(C)=oxygen(O) stretching at approximately 2100 cm⁻¹.

48. The reduction method according to claim 43, wherein the charcoal-based material exhibits the infrared absorption of oxygen(O)-hydrogen(H) stretching at approximately 3000 cm⁻¹.

49. The reduction method according to claim 43, wherein the charcoal-based material exhibits the infrared absorption of carbon(C)-oxygen(O)-carbon(C) stretching in a range of approximately 1000 to 1200 cm⁻¹, the infrared absorption of carbon(C)=carbon(C) symmetric stretching at approximately 1600 cm⁻¹, the infrared absorption of carbon(C)=oxygen(O) stretching at approximately 2100 cm⁻¹, and the infrared absorption of oxygen(O)-hydrogen(H) stretching at approximately 3000 cm⁻¹.

50. The reduction method according to claim 43, wherein the positive electrode contains at least one type of metal and oxide thereof.

51. The reduction method according to claim 50, wherein the oxide is a lower oxide of manganese indicated by MnO_{y}, wherein y is the number of oxygen atoms determined by the valence of the manganese (Mn), and is less than 2.

52. The reduction method according to claim 43, wherein the charcoal-based material is in powder form, and the electrode material containing the charcoal-based material is supported on an electrically conductive base to constitute the positive electrode.

53. The reduction method according to claim 52, wherein the electrically conductive base is gas-permeable.

54. The reduction method according to claim 43, wherein the electrolyte is a neutral aqueous electrolyte.

55. The reduction method according to claim 43, wherein the negative electrode reaction is an oxidation reaction that electrochemically removes electrons from a fuel substance that is soluble in the electrolyte.

56. The reduction method according to claim 43, wherein the electrolyte comprises at least one type of sugar and alcohol.
